(19) United States
(12) Patent Application Publication
(10) Pub. No.: US 2008/0014939 A1
(43) Pub. Date: Jan. 17, 2008

(54) Method for providing service in a communication system based on IP multimedia subsystem

(75) Inventor: DeugKu Chang, Yongin-si (KR)

Correspondence Address: DOCKET CLERK, P.O. DRAWER 800889, DALLAS, TX, 75380, US

(73) Assignee: Samsung Electronics Co., Ltd.

(21) Appl. No.: 11/823,609

(22) Filed: Jun. 28, 2007

(30) Foreign Application Priority Data
Jun. 30, 2006 (KR) 2006-61089

(51) Int. Cl. H04Q 7/20

(52) U.S. Cl. 455/435.2; 455/435.1

(57) ABSTRACT

A registration method for providing a service to a terminal in a communication system based on an IP (Internet Protocol) Multimedia Subsystem (IMS). In the registration method, the terminal sends a message including its available service information. A server that manages service information and presence information of the terminal extracts the service information available by the terminal from a particular header of the message and registers the extracted service information.

### PRIORITY

The present application claims the benefit under 35 U.S.C. §119(a) of a Korean Patent Application filed in the Korean Intellectual Property Office on Jun. 30, 2006 and assigned Serial No. 2006-61089, the disclosure of which is incorporated herein by reference.

### TECHNICAL FIELD OF THE INVENTION

The present invention relates generally to a mobile communication system based on an IP (Internet Protocol) Multimedia Subsystem (IMS), and in particular, to a method for providing services in an IMS-based communication system.

### BACKGROUND OF THE INVENTION

IMS is the core technology for providing new services in an all IP-based next generation communication environment. That is, IMS is a technology capable of implementing new services, such as a multimedia service and a wire/wireless integrated service, in an easier way at a low cost.

IMS, an open architecture that enables an IP multimedia service in the mobile, wired, and convergence environments, is based on Session Initiation Protocol (SIP) signaling. For example, in the IMS-based communication environment, subscribers can enjoy point-to-multipoint real-time group calls, interactive mobile games, real-time Instant Messaging (IM) services, and the like. IMS has been proposed in the 3^{rd} generation mobile communication system based on an IP network in the course of preparing the wireless network standard for interworking and compatibility between different service networks. Currently, application of IMS is extended to the core technology that supports the next generation supplementary communication service and wire/wireless convergence.

However, the IMS-related application services proposed up to now do not take characteristics of terminals into consideration. For example, The characteristic(s) of a terminal as used herein, can be a capability indicating which service(s) the terminal can use. Therefore, there are no definitions for various scenario procedures related to the capability of the terminals.

### SUMMARY OF THE INVENTION

To address the above-discussed deficiencies of the prior art, it is a primary object to provide a registration procedure for a terminal in an IMS-based communication system.

Another aspect of the present invention is to provide various services according to a capability of a terminal in an IMS-based communication system.

According to one aspect of the present invention, there is provided a registration method for providing a service to a terminal in a communication system based on an IP (Internet Protocol) Multimedia Subsystem (IMS). The registration method includes transmitting from the terminal a message including available service information associated with the terminal; in a server that manages service information and presence information of the terminal, extracting the available service information from a particular header of the message transmitted by the terminal; and registering the extracted available service information.

According to another aspect of the present invention, there is provided a method for receiving a particular service for use in a communication system based on an IP (Internet Protocol) Multimedia Subsystem (IMS). The service receiving method includes transmitting from an originating terminal a first message associated with the particular service; in a Serving-Call Session Control Function (S-CSCF), receiving the first message and sending the first message to a first server capable of providing the particular service; in the first server, determining capability information associated with a terminating terminal targeted by the first message; and in the first server, inserting the determined capability information of the terminating terminal in a particular header of the first message and transmitting the first message.

According to a further aspect of the present invention, there is provided a method for changing a service capability of a terminal in a communication system based on an IP (Internet Protocol) Multimedia Subsystem (IMS). The service capability changing method includes inactivating in the terminal a corresponding service so as not to receive at least one of the available active services of the terminal; transmitting a message including service information of the inactivated service; receiving the message in a server that manages presence information and capability information associated with the terminal; in the server, extracting service information included in the message, registering the extracted service information, and notifying the terminal that the service information has been registered after being changed; and providing the changed service information associated with the terminal to other servers that provide other services.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram illustrating a configuration of an IMS-based communication system to which embodiments of the present invention are applicable;

FIG. 2 is a signaling diagram illustrating a procedure for registering a terminal capability in an IMS-based communication system according to a first embodiment of the present invention;

FIG. 3 is a signaling diagram illustrating a procedure for controlling a service session taking a terminal capability into account in an IMS-based communication system according to a second embodiment of the present invention;

FIGS. 4A to 4C are signaling diagrams illustrating a procedure in which a service session is changed taking a terminal capability into account in an IMS-based communication system according to a second embodiment of the present invention;

FIG. 5 is a signaling diagram illustrating a procedure in which a PTT session is set up in an IMS-based communication system according to the second embodiment of the present invention; and

FIG. 6 is a signaling diagram illustrating a procedure for activating or inactivating a capability of a terminal in an IMS-based communication system according to a third embodiment of the present invention.

### DETAILED DESCRIPTION OF THE INVENTION

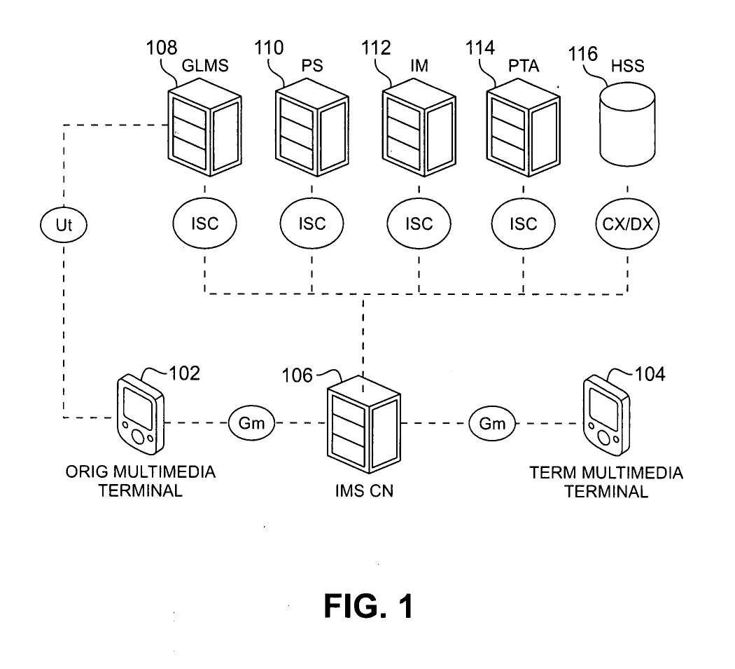

FIGS. 1 through 6, discussed below, and the various embodiments used to describe the principles of the present disclosure are by way of illustration only and should not be construed in any way to limit the scope of the disclosure. Those skilled in the art will understand that the principles of the present disclosure may be implemented in any suitably arranged communication system.

The present invention provides a method for providing various services taking a capability of a terminal into account in a communication system based on an IP (Internet Protocol) Multimedia Subsystem (IMS).

FIG. 1 is a diagram illustrating a configuration of an IMS-based communication system to which embodiments of the present invention are applicable.

Referring to FIG. 1, the IMS-based communication system includes an originating multimedia terminal 102, a terminating multimedia terminal 104, an IMS Core Network (IMS CN) 106, a Group List Management Server (GLMS) 108 for providing a group management function of a subscriber, a Presence Server (PS) 110 for maintaining and managing presence information of a terminal, an Instant Messaging (IM) server 112 for providing an IM service, a Push-To-All (PTA) server 114, and a Home Subscriber Server (HSS) 116.

A description will now be made of elements constituting the IMS-based communication system.

Each of the originating and terminating multimedia terminals 102 and 104 may be a wired, wireless, or wired/wireless integrated terminals, and has the capability to process multimedia information. For the capability of the terminals 102 and 104 in the present invention, reference is made to IETF RFC 3840 Indicating User Agent Capabilities in the SIP, and a new capability ‘allowedservices’ that may be defined as follows.

[symbol] Definition of Capability of Terminal

1. Hardware Capability

1) audio
(1) ‘G.711’, ‘G.723’, ‘G.726’, ‘G.729’, . . .
(2) ‘AMR’, ‘EVRC’, . . .

2) video
(1) ‘H.263’, ‘H.264’, . . .

3) mobility
(1) ‘fixed’, ‘mobility’, . . .

2. Software Capability

1) actor
(1) ‘principal’, ‘attendant’, ‘msg-taker’, . . .

2) methods
(1) ‘INVITE’, ‘BYE’, ‘CANCEL’, ‘OPTIONS’

3) language
(1) ‘en’, ‘de’, ‘fr’, ‘kr’ . . .

4) events
(1) ‘presence’, ‘message-summary’ . . .

5) priority
(1) ‘non-urgent’, ‘normal’, ‘urgent’, ‘emergency’ . . .

6) class
(1) ‘business’, ‘personal’, ‘home’ . . .

7) description
(1) ‘PC’, ‘PDA’, ‘phone’ . . .

8) duplex
(1) ‘full’, ‘half’, ‘send-only’, ‘receive-only’ . . .

9) data

10) scheme

11) type

12) isfocus

13) text

14) extensions

3. Service Capability (Service Capability)

1) application

2) allowed services
(1) ‘PS’, ‘IM’, ‘PTA’, ‘VT’, ‘VoIP’

In the foregoing, VT is the abbreviation of Video Telephony, and a VT service is provided to subscribers using an audio/video-based call service.

An IMS service subscriber registers a capability of its own terminal in the PS 110 via the IMS CN 106 according to a service registration procedure.

The IMS CN 106 controls a session setup and release function between an originating terminal and a terminating terminal. That is, the IMS CN 106 performs a service triggering function for providing a service with a relevant application server according to service profile information of a sender or a recipient after analyzing an SIP message received from the sender or the recipient.

The PS 110, an application server for providing a presence service, performs an authentication procedure upon receipt of a registration message delivered by the service registration procedure of the subscriber. Thereafter, the PS 110 performs a 3rd Party Registration procedure depending on the registered subscriber service profile information. The 3rd Party Registration procedure will now be described below. To receive a normal service, the subscriber performs a registration procedure based on a REGISTER message. In the course of the registration procedure, when there is a need to perform a procedure for receiving a REGISTER message and pre-processing the REGISTER message before service provisioning, for a particular service, the 3rd Party Registration procedure allows the IMS CN 106 to send a REGISTER message to a corresponding service server before the processing.

Another PS application server, upon receipt of the message, analyzes the received message, registers terminal capability information and presence information of the subscriber in a presence record field for the corresponding subscriber, and then delivers an answer (or response) message to the subscriber via the IMS CN 106.

The GLMS 108 is an application server for providing functions for registering/changing/deleting/accessing group list information of a corresponding subscriber through direct interworking with the subscriber. Also, the GLMS 108 performs a function of delivering changed profile information of the subscriber in association with a relevant application server when there is a change in the information by the subscriber due to registration/changing/deletion functions.

The IM server 112, an application server for providing an IM service to a subscriber, performs functions for delivering a message received from an originating or terminating multimedia terminal to a terminating or originating multimedia terminal via the IMS CN 106, depending on presence information and terminal capability information of the subscriber.

The PTA server 114, an application server for providing Push-To-Talk (PTT), Push-To-View (PTV), and Push-To-Data (PTD) services to the subscriber, performs functions for setting-up and releasing a service session.

The HSS 116 is a database for managing subscriber information, such as subscriber registration/change management, authentication, right assignment, charging, etc.

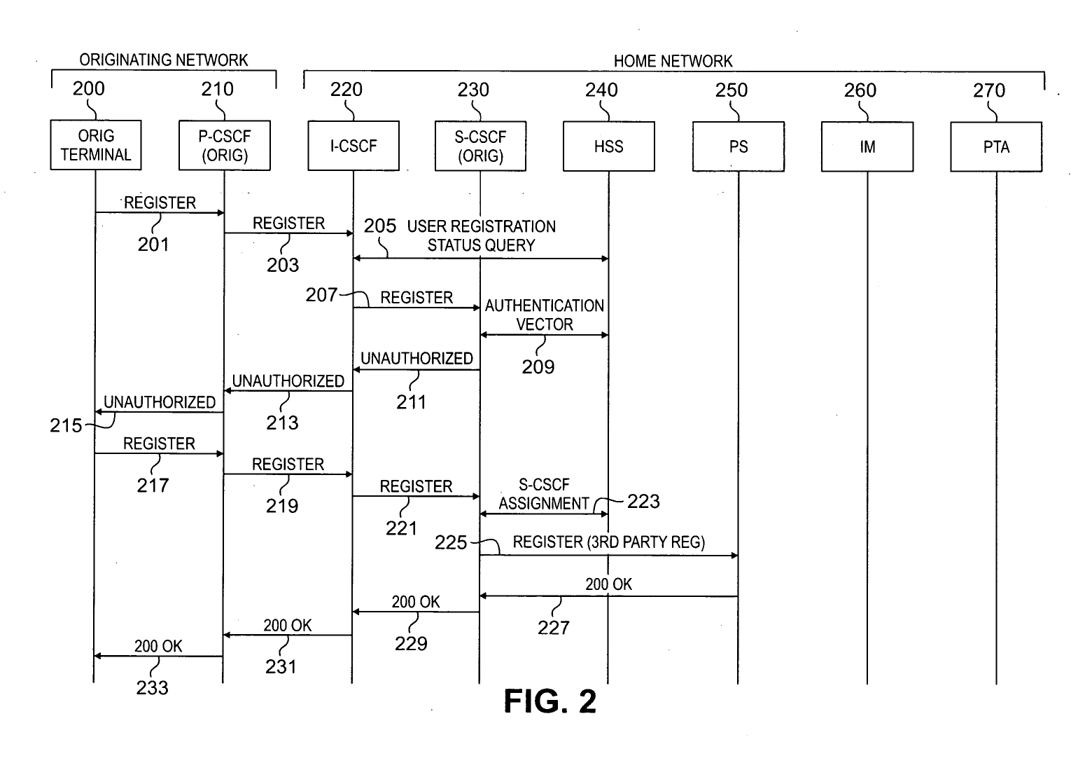

With reference to FIGS. 2 to 6, a description will now be made of various service scenarios in an IMS-based communication system.

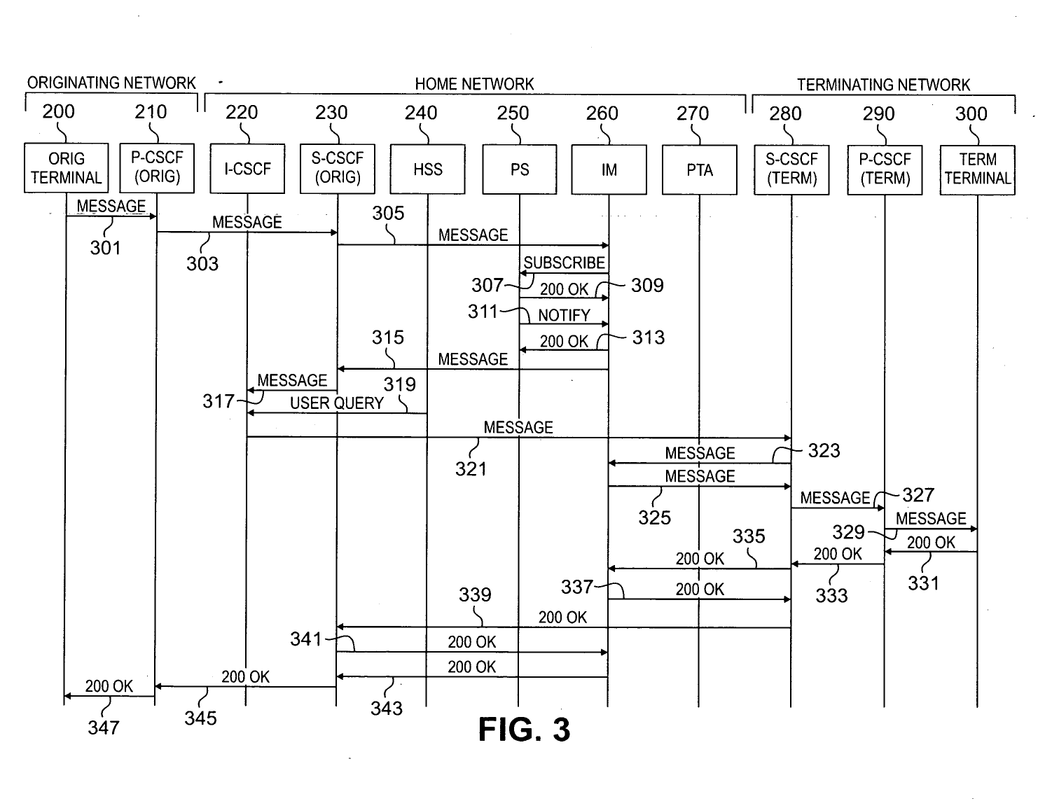

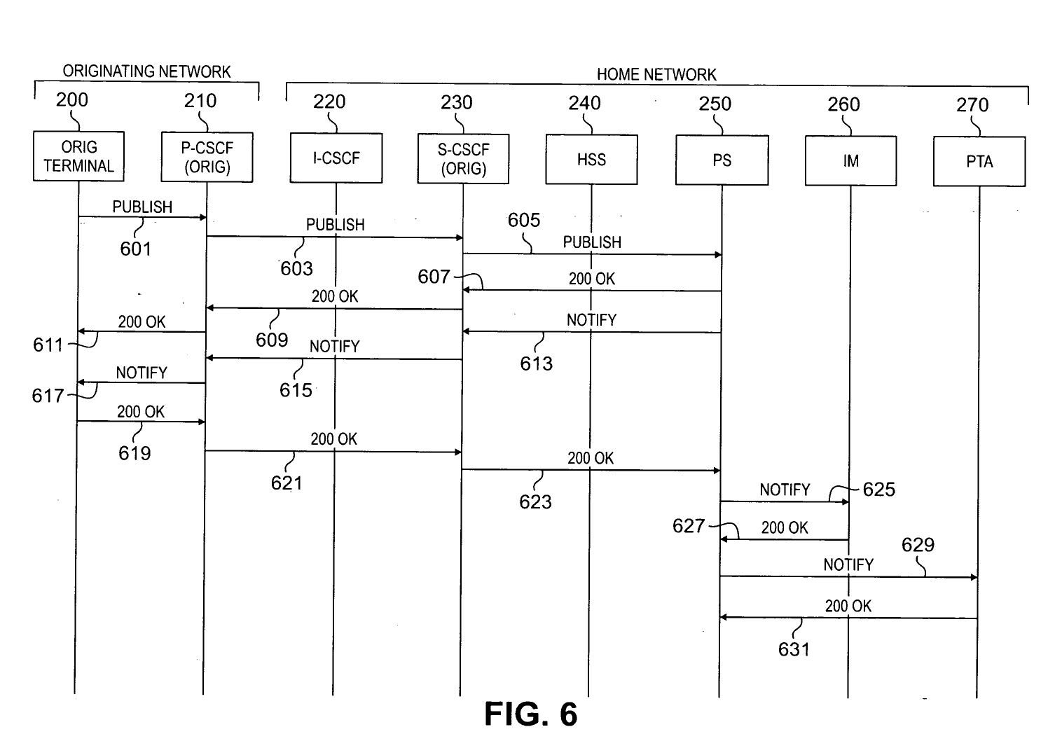

The present invention can be roughly divided into three embodiments. A first embodiment provides a method (FIG. 2) of setting and registering capabilities of originating and terminating multimedia terminals. A second embodiment provides a method (FIGS. 3 to 5) of controlling or setting a service using the registered capabilities of the terminals. A third embodiment provides a method (FIG. 6) of controlling a service capability according to a preference of a subscriber.

FIG. 2 is a signaling diagram illustrating a procedure for registering a terminal capability in an IMS-based communication system according to a first embodiment of the present invention.

Referring to FIG. 2, a procedure for registering a capability of an originating terminal can be roughly divided into 4 steps: (1) a terminal capability setting step by an originating subscriber, (2) a registration request step based on the set of capability information, (3) a step of performing routing to a PS by a 3rd Party Registration procedure, and (4) a step in which the PS registers capability information of a subscriber terminal.

An originating terminal 200 sends a REGISTER message, or a request message for service capability registration, to a Proxy-Call Session Control Function (P-CSCF) 210 in step 201. In the present invention, a contact header of the REGISTER message includes therein capability information of a terminal set by a subscriber, and service information registered by the subscriber is included in an ‘allowedservice’ field of the message. That is, the REGISTER message according to the present invention can include the following information.

REGISTER . . .

Contact: *; allowedservices=“PS, IM, PTA, VT, VoIP . . . ”

Contact: *; +g.allowedservices=“PS, IM, PTA, VT, VoIP . . . ”

Contact: *; +g.3gpp.allowedservices=“PS, IM, PTA, VT, VoIP . . . ”

Contact: *; +sip.allowedservices=“PS, IM, PTA, VT, VoIP . . . ”

The P-CSCF 210 sends the REGISTER message to an Interrogating-Call Session Control Function (I-CSCF) 220 in step 203. The I-CSCF 220 performs subscriber registration status query (User Registration Status Query) with an HSS 240 in step 205, and sends the REGISTER message to a Serving-Call Session Control Function (S-CSCF) 230 in step 207.

The S-CSCF 230 and the HSS 240 determine in step 209 authentication success or failure for the originating terminal 200 using an authentication vector generated with an authentication key of the corresponding originating terminal 200. It is assumed herein that the authentication for originating terminal 200 failed. Therefore, the S-CSCF 230 sends an Unauthorized message indicating the authentication failure to the I-CSCF 220 in step 211. Thereafter, the Unauthorized message is forwarded to the originating terminal 200 via the I-CSCF 220 and the P-CSCF 210 in steps 211, 213 and 215. For the authentication, the predefined authentication procedure can be used.

The originating terminal 200 sends a REGISTER message to the P-CSCF 210 in step 217. Thereafter, the REGISTER message is forwarded to the S-CSCF 230 via the P-CSCF 210 and the I-CSCF 220 in steps 219 and 221. The S-CSCF 230 performs an S-CSCF assignment procedure with the HSS 240 in step 223. That is, the S-CSCF 230 checks a contact header in a header of the received REGISTER message, and if capability information of the terminal is included therein, the S-CSCF 230 captures the capability information, processes it into data, and transmits the data to a PS 250 in step 225.

The PS 250 registers the received data, i.e. the capability information of the terminal, in presence service attribute field for each individual subscriber. The capability information of the terminal includes service capability information additionally defined in the present invention. Thereafter, a 200 OK message indicating registration success is sent to the originating terminal 200 via the HSS 240, the S-CSCF 230, the I-CSCF 220 and the P-CSCF 210 in steps 227, 229, 231, and 233.

FIG. 3 is a signaling diagram illustrating a procedure for controlling a service session taking a terminal capability into account in an IMS-based communication system according to a second embodiment of the present invention.

In FIG. 3, a procedure for controlling an IM service will be described by way of example.

An originating terminal 200 sends in step 301 to a P-CSCF 210 a ‘MESSAGE’ message including message information that it desires to deliver to a terminating terminal 300. The P-CSCF 210 sends the ‘MESSAGE’ message to an S-CSCF 230 in step 303. The S-CSCF 230 checks an Accept-Contact header in a header of the ‘MESSAGE’ message, and if the Accept-Contact header satisfies an IM service triggering condition, the S-CSCF 230 sends the ‘MESSAGE’ message to an IM server 260 in step 305.

The IM server 260 sends a SUBSCRIBE message to a PS 250 in step 307, and receives a 200 OK message and a NOTIFY message from the PS 250 in steps 309 and 311. The IM server 260 sends a 200 OK message to the PS 250 in step 313. Steps 307, 309, 311 and 313 correspond to a procedure in which the IM server 260 acquires presence information and capability information of the terminating terminal 300 and then processes the acquired information. If the IM server 260 has the presence information of the terminating terminal 300, it performs a routing to the terminating terminal 300 using the presence information. However, if the IM server 260 has no presence information of the terminating terminal 300, it sends a SUBSCRIBE message to the PS 250 to acquire presence information of the terminating terminal 300, and performs a routing procedure to the terminating terminal 300 after receiving an answer thereto.

In summary, the IM server 260 can perform the following procedure for the terminating terminal 300:

1) The IM server 260 performs a routing procedure to the terminating terminal 300 when a capability of the terminating terminal 300 is normal.

2) The IM server 260 performs a reject procedure for the case where a capability of the terminating terminal 300 does not provide a corresponding service.

3) The IM server 260, when the terminating terminal 300 is in an Out-of-Service presence, performs a procedure for returning after storing corresponding presence information in a network-based storing space according to a preset policy.

4) The IM server 260 performs a routing procedure to a designated terminal, when the terminating terminal 300 is in an Out-of-Service presence and is registered as a multi-terminal.

The IM server 260 sends a ‘MESSAGE’ message to the S-CSCF 230 in step 315, and the S-CSCF 230 forwards the ‘MESSAGE’ message to an I-CSCF 220 in step 317. The I-CSCF 220 and an HSS 240 perform subscriber query (User Query) in step 319, and the I-CSCF 220 forwards the ‘MESSAGE’ message to a terminating S-CSCF 280 in step 321. The S-CSCF 280 checks an Accept-Contact header in a header of the ‘MESSAGE’ message and then sends a ‘MESSAGE’ message to the IM server 260 in step 323. The Accept-Contact header can be a Contact header according to system implementation. The IM server 260 sends the ‘MESSAGE’ message to the S-CSCF 280 in step 325. Thereafter, the ‘MESSAGE’ message is forwarded to the terminating terminal 300 via a P-CSCF 290 in steps 327 and 329. A description of the following process in which a 200 OK message is delivered from the terminating terminal 300 to the originating terminal 200 in steps 331 to 347 will be omitted herein.

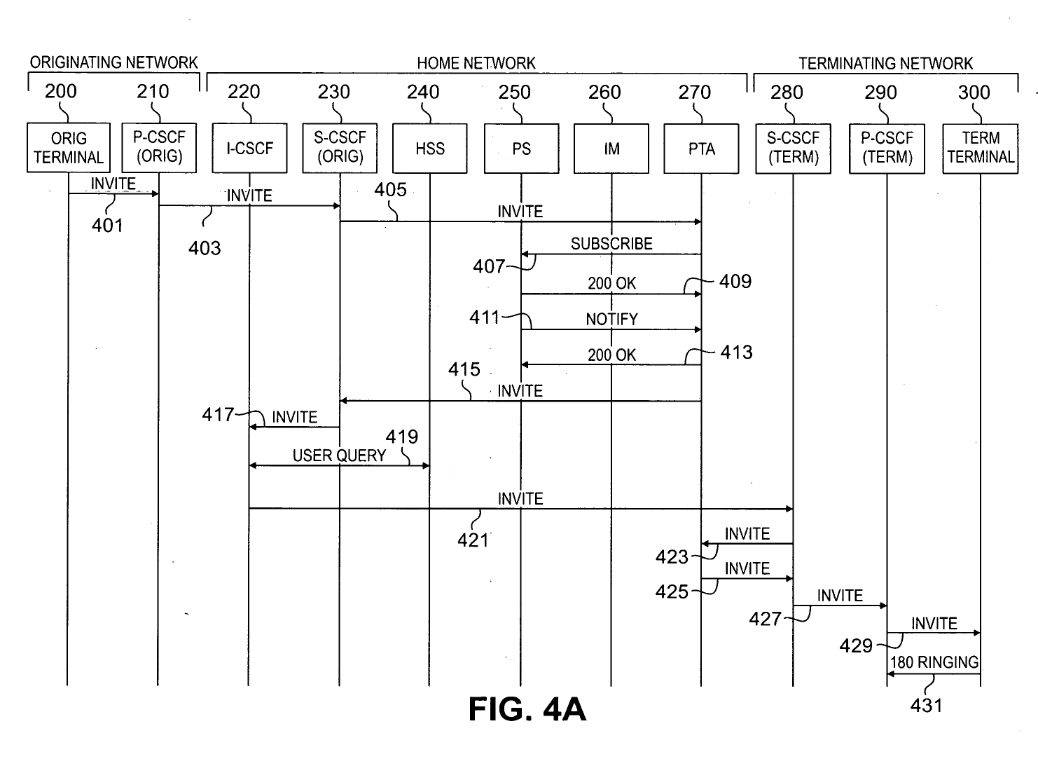

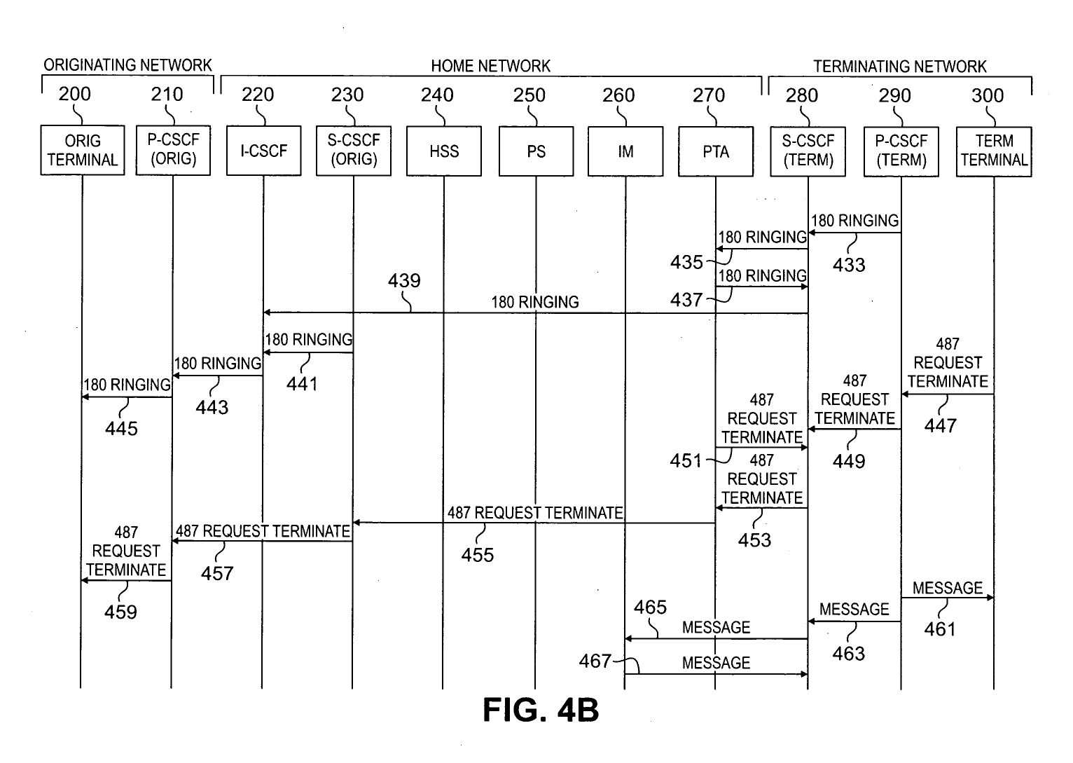

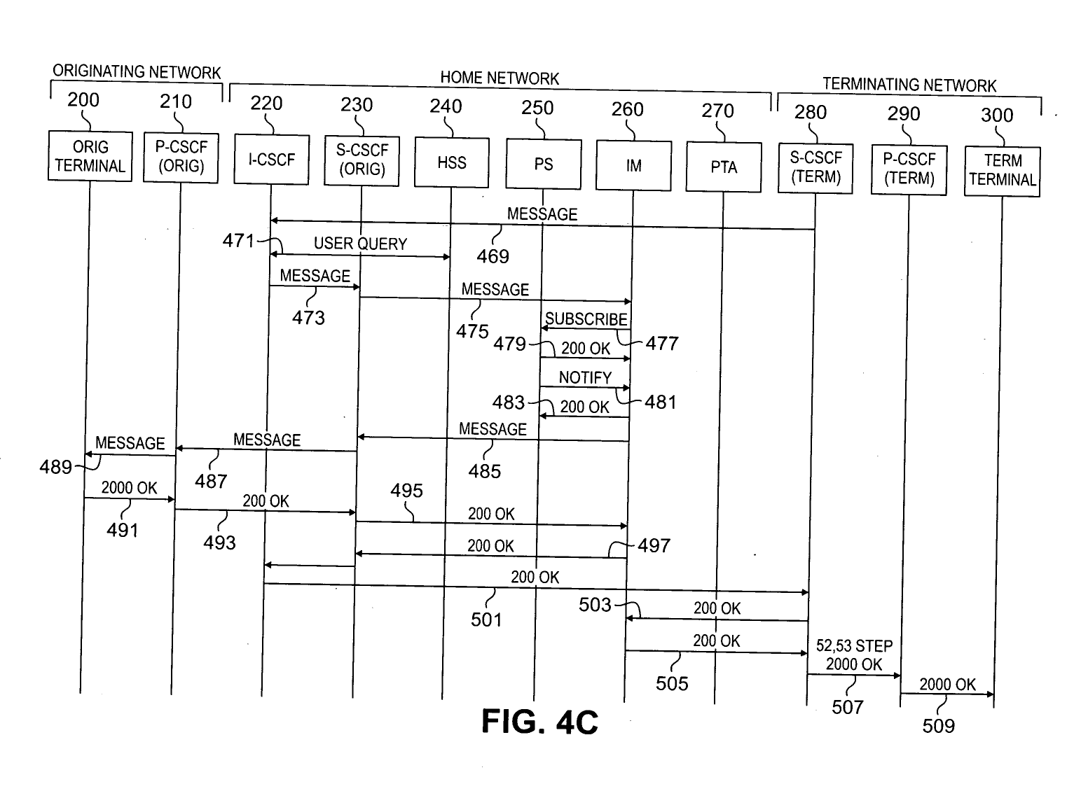

FIGS. 4A to 4C are signaling diagrams illustrating a procedure in which a service session is changed taking a terminal capability into account in an IMS-based communication system according to a second embodiment of the present invention.

Referring to FIGS. 4A to 4C, an originating terminal 200 sends an INVITE message to a P-CSCF 210 for PTA session setup in step 401. The P-CSCF 210 forwards the INVITE message to an S-CSCF 230 in step 403. The S-CSCF 230 checks an Accept-Contact header in a header of the INVITE message, and if the Accept-Contact header satisfies a triggering condition, the S-CSCF 230 sends the INVITE message to a PTA server 270 in step 405, recognizing that the message is a PTA service session request.

The PTA server 270 performs the procedure being equivalent to that in steps 307, 309, 311 and 313 of FIG. 3, with a PS 250 in steps 407, 409, 411, and 413. Similarly, the capability information of the originating terminal 200 is stored in an Accept-Contact header, and then delivered to a terminating terminal 300.

The PTA server 270 sends an INVITE message to the S-CSCF 230 in step 415, and the S-CSCF 230 forwards the INVITE message to an I-CSCF 220 in step 417. Thereafter, the I-CSCF 220 performs a subscriber query with an HSS 240 in step 419, and forwards the INVITE message to a terminating S-CSCF 280 in step 421. The S-CSCF 280 exchanges an INVITE message with the PTA server 270 in steps 423 and 425, and forwards the INVITE message to a P-CSCF 290 in step 427.

The P-CSCF 290 forwards the INVITE message to the terminating terminal 300 in step 429. It is assumed herein that the terminating terminal 300 is in a Manual Answer Mode that determines an answer according to decision of the terminating terminal.

After receiving the INVITE message, the terminating terminal 300 should be able to check capability information, especially service capability information, of the originating terminal 200, and then recognize an active service and an inactive service of the originating terminal 200. Therefore, the INVITE message can have the following format.

INVITE . . .

Contact: *; allowedservices=“PS, IM, PTA, VT, VoIP . . . ”

Contact: *; +g.allowedservices=“PS, IM, PTA, VT, VoIP . . . ”

Contact: *; +g.3gpp.allowedservices=“PS, IM, PTA, VT, VoIP . . . ”

Contact: *; +sip.allowedservices=“PS, IM, PTA, VT, VoIP . . . ”

Accept-Contact: *;allowedservices=“PS, IM, PTA, VT, VoIP”

Accept-Contact: *; +g.allowedservices=“PS, IM, PTA, VT, VoIP . . . ”

Accept-Contact: *; +g.3gpp.allowedservices=“PS, IM, PTA, VT, VoIP . . . ”

Accept-Contact: *; +sip.allowedservices=“PS, IM, PTA, VT, VoIP . . . ”

Thereafter, the originating terminal 200 receives a 180 Ringing message sent from the terminating terminal 300 in steps 431 to 445.

When the terminating terminal 300 cannot set up a PTA session due to a particular situation, it can switch to another service. In the following exemplary description, the terminating terminal 300 changes a service to an IM session as it cannot set up the PTA session.

The terminating terminal 300 sends in step 447 to the P-CSCF 290 a 487 Request Terminate message meaning that it will provide an answer due to the service change. The 487 Request Terminate message is finally received at the originating terminal 200 in steps 449 to 459. Upon receipt of the 487 Request Terminate message in step 459, the originating terminal 200 displays a presence indicating the service switch by the terminating terminal 300.

The terminating terminal 300 sends a ‘MESSAGE’ message including its capability information to the P-CSCF 290 in step 461. The ‘MESSAGE’ message can have the following format.

MESSAGE . . .

Contact: *; allowedservices=“PS, IM, PTA, VT, VoIP . . . ”

Contact: *; +g.allowedservices=“PS, IM, PTA, VT, VoIP . . . ”

Contact: *; +g.3gpp.allowedservices=“PS, IM, PTA, VT, VoIP . . . ”

Contact: *; +sip.allowedservices=“PS, IM, PTA, VT, VoIP . . . ”

Accept-Contact: *; allowedservices=“PS, IM, PTA, VT, VoIP . . . ”

Accept-Contact: *; +g.allowedservices=“PS, IM, PTA, VT, VoIP . . . ”

Accept-Contact: *; +g.3gpp.allowedservices=“PS, IM, PTA, VT, VoIP . . . ”

Accept-Contact: *; +sip.allowedservices=“PS, IM, PTA, VT, VoIP . . . ”

Thereafter, the ‘MESSAGE’ message is forwarded to an IM server 260 via a path of steps 463 to 477. The IM server 260 acquires presence information and capability information of the terminating terminal 300 through message exchange with the PS 250, and then transmits in step 485 the acquired information to the S-CSCF 230 along with an Accept-Contact header of the ‘MESSAGE’ message. The following steps 487 to 509 are normal steps, so a detailed description thereof will be omitted herein.

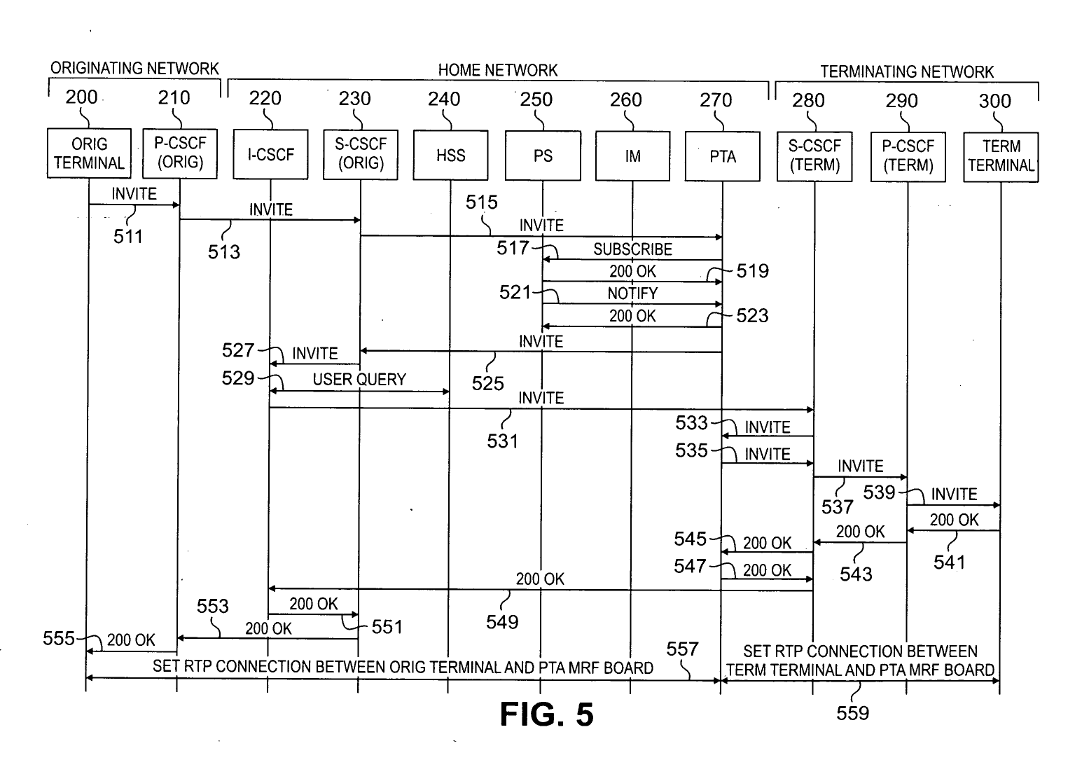

FIG. 5 is a signaling diagram illustrating a procedure in which a PTT session is set up in an IMS-based communication system according to the second embodiment of the present invention.

A partial description of FIG. 5, which has already been provided in other drawings, will be omitted herein. It is assumed in FIG. 5 that a particular service, for example, a PTT session is set up. A PTA server 270 acquires presence information and capability information of a terminating terminal 300 from a PS 250 in steps 517 to 523. Thereafter, the PTA server 270 sends a request for PTT session setup to the terminating terminal 300 in steps 531 to 539, and the terminating terminal 300 immediately sets up a PTT session in an Automatic Answer Mode in steps 557 to 559.

FIG. 6 is a signaling diagram illustrating a procedure for activating or inactivating a capability of a terminal in an IMS-based communication system according to a third embodiment of the present invention.

Referring to FIG. 6, a terminal should inactivate or activate a particular service when it cannot receive the particular service or when use of the particular service is restricted by a subscriber.

An originating terminal 200 sends a PUBLISH message to a P-CSCF 210 in step 601. The PUBLISH message includes information indicating activation or inactivation of a service that the originating terminal 200 can receive, and this message can have the following format.

PUBLISH•••
...
<tuple id=“1”>
...
<rp : allowedservices id=“PS”>
<rp: activities><rp:online></rp:activities>
<rp : allowedservices id=“IM”>
<rp: activities><rp:online></rp:activities>
<rp : allowedservices id=“PTA”>
<rp: activities><rp:offline></rp:activities>
<rp : allowedservices id=“VT”>
<rp: activities><rp:offline></rp:activities>
<rp : allowedservices id=“VoIP”>
<rp: activities><rp:online></rp:activities>
</tuple>

The P-CSCF 210 sends the PUBLISH message to an S-CSCF 230 in step 603. The S-CSCF 230 forwards the PUBLISH message to a PS 250 in step 605. Upon receipt of the PUBLISH message, the PS 250 checks whether there is any change in capability of the originating terminal 200. If there is a change in the capability of the originating terminal 200, the PS 250 recognizes that it should register the change and notify it to other nodes. Therefore, the PS 250 sends a 200 OK message to the S-CSCF 230 in step 607, and the 200 OK message is forwarded to the originating terminal 200 in steps 609 and 611.

Thereafter, the PS 250 sends a NOTIFY message to the S-CSCF 230 in step 613. The NOTIFY message is a message used for notifying the processing result of the service activation or inactivation setup requested by the originating terminal 200. The NOTIFY message can have the following format.

NOTIFY•••
...
<tuple id=“1”>
...
<rp:allowedservices id=“PS”>
<rp:activities><rp:online></rp:activities>
<rp:allowedservices id=“IM”>
<rp:activities><rp:online></rp:activities>
<rp:allowedservices id=“PTA”>
<rp:activities><rp:offline></rp:activities>
<rp:allowedservices id=“VT”>
<rp:activities><rp:offline></rp:activities>
<rp:allowedservices id=“VoIP”>
<rp:activities><rp:offline></rp:activities>

The NOTIFY message is forwarded to the originating terminal 200 in steps 615 and 617. In answer to the NOTIFY message, the originating terminal 200 sends a 200 OK message to the P-CSCF 210 in step 619. Thereafter, the 200 OK message is forwarded to the PS 250 in steps 621 and 623, and the PS 250 sends a NOTIFY message to an IM server 260 and a PTA server 270 in steps 625 and 629. It should be noted that the process in which the PS 250 sends the NOTIFY message to the IM server 260 and the PTA server 270 can also be performed before step 623.

As is apparent from the foregoing description, the present invention can provide various services using a capability of a terminal in an IMS-based communication system. As a result, a service provider can make gains through realization of various service provisioning scenarios.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a communication system based on an IP (Internet Protocol) Multimedia Subsystem (IMS), a registration method for providing a service to a terminal, the registration method comprising:
transmitting from the terminal a message including available service information associated with the terminal;
in a server that manages service information and presence information of the terminal, extracting the available service information from a particular header of the message transmitted by the terminal; and
registering the extracted available service information.

2. The registration method of claim 1, wherein the message is a normal REGISTER message including available service information associated with the terminal.

3. The registration method of claim 2, wherein the available service information comprises service information for at least one of a presence information service, an Instant Messaging (IM) service, a Push-To-All (PTA) service, a Voice over IP (VoIP) service, and a Video Telephony (VT) service.

4. The registration method of claim 1, wherein the particular header is at least one of a contact header and an accept-contact header.

5. For use in a communication system based on an IP (Internet Protocol) Multimedia Subsystem (IMS), a method for receiving a particular service, the method comprising:
transmitting from an originating terminal a first message associated with the particular service;
in a Serving-Call Session Control Function (S-CSCF), receiving the first message and sending the first message to a first server capable of providing the particular service;
in the first server, acquiring capability information associated with a terminating terminal targeted by the first message; and
in the first server, inserting the acquired capability information of the terminating terminal in a particular header of the first message and transmitting the first message.

6. The method of claim 5, wherein the particular header is at least one of a contact header and an accept-contact header.

7. The method of claim 5, further comprising:
transmitting the first message from the first server when the terminating terminal has a capability of receiving the first message.

8. The method of claim 5, further comprising:
when the terminating terminal has a capability of receiving the first message of the originating terminal but cannot receive the first message due to a particular situation,
transmitting from the terminating terminal a second message indicating session termination for the particular service, the second message targeting the originating terminal;
receiving the second message in the originating terminal and displaying information indicating that the particular service is switched by the terminating terminal to a second particular service;
transmitting from the terminating terminal a third message associated with the second particular service to which the particular service has been switched;
in a second server that provides the second particular service, acquiring capability information of the originating terminal; and
in the second server, inserting the acquired capability information of the originating terminal in a particular header of the third message, and transmitting the third message.

9. For use in a communication system based on an IP (Internet Protocol) Multimedia Subsystem (IMS), a method for changing a service capability of a terminal, the method comprising:
inactivating in the terminal a corresponding service so as not to receive at least one of the available active services of the terminal;
transmitting a message including service information associated with the inactivated service;
receiving the message in a server that manages presence information and capability information associated with the terminal;
in the server, extracting service information included in the message, registering the extracted service information, and notifying the terminal that the service information has been registered after being changed; and
providing the changed service information associated with the terminal to other servers that provide other services.

10. A communication system based on an Internet Protocol (IP) Multimedia Subsystem (IMS) comprising:
a plurality of servers capable of providing services to a plurality of terminals accessing the communication system;
a first server that manages serviced information and presence information associated with the plurality of terminals, wherein the first server is operable to i) receive from a first one of the plurality of terminals a first message including available service information associated with the first terminal, ii) extract the available service information from a particular header of the first message; and iii) register the extracted available service information.

11. The communication system as set forth in claim 10 wherein the first message is a REGISTER message associated with session initiation protocol (SIP) devices.

12. The communication system as set forth in claim 11 wherein the REGISTER message includes the available service information associated with the first terminal

13. The communication system as set forth in claim 10, wherein the available service information comprises service information associated with a presence information service.

14. The communication system as set forth in claim 10, wherein the available service information comprises service information associated with an Instant Messaging (IM) service.

15. The communication system as set forth in claim 10, wherein the available service information comprises service information associated with a Voice-over-IP service.

16. The communication system as set forth in claim 10, wherein the available service information comprises service information associated with a video telephony service.

17. The communication system as set forth in claim 10, wherein the available service information comprises service information associated with a Push-To_All service.

18. The communication system as set forth in claim 17, wherein the Push-To_All service comprises at least one of a Push-To-Talk Service, a Push-To-View service, and a Push-To-Data Service.

19. The communication system as set forth in claim 10, wherein the particular header comprises a contact header.

20. The communication system as set forth in claim 10, wherein the particular header comprises an accept-contact header.
